(19) United States
(12) Patent Application Publication
(10) Pub. No.: US 2013/0098819 A1
(43) Pub. Date: Apr. 25, 2013

(54) ENHANCED RESIN REGENERATION

(71) Applicant: Oxygenator Water Technologies, Inc., St. Louis Park, MN (US)

(72) Inventor: Mark Rolfes, Bloomington, MN (US)

(73) Assignee: Oxygenator Water Technologies, Inc., St. Louis Park, MN (US)

(21) Appl. No.: 13/657,311

(22) Filed: Oct. 22, 2012

Related U.S. Application Data
(60) Provisional application No. 61/550,752, filed on Oct. 24, 2011.

(51) Int. Cl. C02F 5/00

(52) U.S. Cl. 210/190

(57) ABSTRACT

An oxygen and hydrogen emitter that is an electrolytic cell is disclosed. When the anode and cathode are separated by a critical distance, very small microbubbles and nanobubbles of oxygen and hydrogen are generated from aqueous solutions. The very small bubbles remain in suspension in the aqueous solution, forming a solution saturated in oxygen and hydrogen. A flow-through model for oxygenating and adding hydrogen bubbles in flowing water for water softeners is disclosed. Increasing the oxygen and hydrogen content of flowing water in residential and commercial water softeners to reduce sodium usage and increase resin regeneration efficiency with the use of an emitter is disclosed.

### CLAIM OF PRIORITY

This patent application claims the benefit of priority, under 35 U.S.C. §119(e), to U.S. Provisional Patent Application Ser. No. 61/550,752, entitled “ENHANCED RESIN REGENERATION,” filed on Oct. 24, 2011, which is hereby incorporated by reference herein in its entirety.

### FIELD OF THE INVENTION

This invention relates to the electrolytic generation of microbubbles of oxygen and hydrogen for increasing the oxygen and hydrogen content of flowing water. This invention also relates to the use of superoxygenated water to increase the efficiency of residential and commercial water softeners. The flow-through model is useful for adding oxygen and hydrogen.

### BACKGROUND

Many benefits may be obtained through raising the oxygen content of aqueous media. Efforts have been made to achieve higher saturated or supersaturated oxygen levels for applications such as the improvement of water quality in ponds, lakes, marshes and reservoirs, the detoxification of contaminated water, culture of fish, shrimp and other aquatic animals, biological culture and hydroponic culture. Organic pollutants from agricultural, municipal and industrial facilities spread through the ground and surface water and adversely affect life forms. Many pollutants are toxic, carcinogenic, or mutagenic. Decomposition of these pollutants if facilitated by oxygen, both by direct chemical detoxifying reactions or by stimulating the growth of detoxifying microflora. Contaminated water is described as having an increased biological oxygen demand (BOD) and water treatment is aimed at decreasing the BOD so as to make more oxygen available for fish and other life forms.

The most common method of increasing the oxygen content of a medium is by sparging with air or oxygen. While this is a simple method, the resulting large bubbles produced simply break the surface and are discharged into the atmosphere. Attempts have been made to reduce the size of the bubbles in order to facilitate oxygen transfer by increasing the total surface area of the oxygen bubbles. U.S. Pat. No. 5,534,143 discloses a microbubble generator that achieves a bubble size of about 0.10 millimeters to about 3 millimeters in diameter. U.S. Pat. No. 6,394,429 discloses a device for producing microbubbles, ranging in size from 0.1 to 100 microns in diameter, by forcing air into the fluid at high pressure through a small orifice.

When the object of generating bubbles is to oxygenate the water, either air, with an oxygen content of approximately 21%, or pure oxygen may be used. The production of oxygen and hydrogen by the electrolysis of water is well known. A current is applied across an anode and a cathode, which are immersed in an aqueous medium. The current may be a direct current from a battery or an AC/DC converter from a line. Hydrogen gas is produced at the cathode and oxygen gas is produced at the anode. The reactions are:

AT THE CATHODE: 4H₂O+4e⁻→4OH⁻+2H₂

AT THE ANODE: 2H₂O→O₂+4H⁺+4e

NET REACTION: 6H₂O→4OH⁻+4H⁺+2H₂+O₂

The energy required to generate one mole of oxygen is 286 kilojoules.

The gasses form bubbles that rise to the surface of the fluid and may be collected. Either the oxygen or the hydrogen may be collected for various uses. The “electrolyte water” surrounding the anode becomes acidic while the electrolytic water surrounding the cathode becomes basic. Therefore, the electrodes tend to foul or pit and have a limited life in these corrosive environments.

Many cathodes and anodes are commercially available. U.S. Pat. No. 5,982,609 discloses cathodes comprising a metal or metallic oxide of at least one metal selected from the group consisting of ruthenium, iridium, nickel, iron, rhodium, rhenium, cobalt, tungsten, manganese, tantalum, molybdenum, lead, titanium, platinum, palladium and osmium. Anodes are formed from the same metallic oxides or metals as cathodes. Electrodes may also be formed from alloys of the above metals or metals and oxides co-deposited on a substrate. The cathode and anodes may be formed on any convenient support in any desired shape or size. It is possible to use the same materials or different materials for both electrodes. The choice is determined according to the uses. Platinum and iron alloys (“stainless steel”) are often preferred materials due to their inherent resistance to the corrosive electrolytic water. An especially preferred anode disclosed in U.S. Pat. No. 4,252,856 comprises vacuum deposited iridium oxide.

The process for utilizing the anodes and cathodes in an aqueous environment to produce oxygen and hydrogen-rich solutions for water purification is captured in U.S. Pat. Nos. 7,670,495; 6,689,262 and 7,396,441.

Water treatment devices, such as water softeners, are generally used to treat water in a home or building. Water softeners are typically used to remove hardness minerals from the water. When treating hard water, an ion exchange resin in a water softener adsorbs calcium and magnesium ions from the water and replaces them with sodium ions. The resin becomes ineffective when the amount of available sodium is depleted and the resin is saturated with calcium and magnesium. The resin must periodically be regenerated. During the regeneration process, water treatment is suspended while the magnesium and calcium ions are flushed from the resin and restored with sodium ions. Typically, the resin is backwashed be reversing the flow of the incoming water to remove any sediment present. Next, the resin bed within the softener comes in contact with a brine solution. The high concentration sodium solution forces the displacement of calcium and magnesium for sodium. After an optimum amount of ion exchange has occurred, the hard water ions and brine solution are discarded from the resin bed. The resin is then regenerated and capable of removing hard water ions.

With the movement to greener technologies and environmental awareness, there is a significant need to reduce the amount of salt used to treat residential and commercial water. Newer water softeners use electronic devices to schedule regenerations based on resin saturation instead of time. When resin saturation reaches a predetermined level, a controller calculates the next regeneration time. Each time regeneration occurs, regardless of the usage, the brine usage assumes total resin saturation. A technology is needed that will increase the efficiency of water softener resin regeneration and reduce the amount of sodium needed in the regeneration process.

None of the prior art describes the utilization of oxygen and hydrogen microbubbles to increase the efficiency of water softener regeneration.

It is therefore the object of this invention to provide a novel method of increasing water softener regeneration and reducing the overall consumption of sodium in the regeneration process for both commercial and residential water softeners.

It is another object of this invention to provide a method in which the oxygen and hydrogen microbubbles can be supplied to a water softener.

### SUMMARY

The present invention provides an oxygen and hydrogen emitter, which is an electrolytic cell that generates very small microbubbles and nanobubbles of oxygen and hydrogen in an aqueous medium, which supersaturates the aqueous medium with oxygen and hydrogen.

The electrodes may be a metal or oxide of at least one mental selected from the group consisting of ruthenium, iridium, nickel, iron, rhodium, cobalt, tungsten, platinum, palladium and osmium or oxides thereof. The electrodes may be formed into open grids or may be closed surfaces. The most preferred cathode is a stainless steel mesh. The most preferred mesh is a 1/16 inch grid. The most preferred anode is platinum and iridium oxide on a support. A preferred support is titanium.

In order to form microbubbles and nanobubbles, the anode and cathode are separated by a specified gap distance. The gap distance ranges from 0.005 inches to 0.140 inches. The preferred gap distance is from 0.045 to 0.060 inches.

Models of different sizes are provided to be applicable to various volumes of aqueous medium to be oxygenated. The public is directed to choose the applicable model based on volume and power requirements of the projected use. Models with low voltage requirements may be advantageous and are suited to oxygenating water and adding hydrogen bubbles.

Controls are provided to regulate the current and timing of electrolysis.

A flow-through model is provided, which may be connected in-line to a watering hose or to a circulating system, such as a water softener. The flow-through model can be formed into a tube. In this model, the anode and cathode may be configured as concentrically aligned cylinders formed from wire grids or mesh. The concentric cylinders fit inside the flow through tube, have their long axes parallel to the long axis of the tube and are positioned such that water will flow in, around and through the cylindrical grids. Alternative designs include configuring the anodes and cathodes as grid or solid plates parallel to the long axis of the tube, or as plates in a wafer stack. Alternatively, the electrodes of these configurations may be placed in a side tube (“T” model) out of the direct flow of water. A single cathode and single anode may be employed or alternatively, multiple electrodes may be employed. For example with the concentric grid cylinders, alternating cathode and anode grid cylinders may be concentrically aligned so that the electrodes are nested one inside the other. With these designs and configurations of electrodes, either of the cathode and anode may be placed next to the inner wall of the flow through tube. Preferably, the anode is placed toward the outside of the tube and the cathode is placed on the inside, contacting the water flow. A feature of the electrode configuration is the gap distance between electrodes. To generate the micro and nano bubbles of oxygen and hydrogen, that gap distance may range from 0.005 inches to 0.140 inches with a preferred gap distance as given above. Protocols are provided to produce superoxygenated and hydrogen saturated water at the desired flow rate and at the desired power usage. Controls are inserted to activate electrolysis when water is flowing and deactivate electrolysis at rest.

This invention includes a method to increase the efficiency of water softeners by application of superoxygenated and hydrogen saturated water. The water treated with the emitter of this invention is one example of superoxygenated and hydrogen bubble-rich water. The use of a flow-through model for the reduction of sodium and increased efficiency of resin regeneration in water softeners for residential and commercial products is disclosed.

### BRIEF DESCRIPTION OF THE DRAWINGS

FIG. 1 is a schematic diagram of a water softener with an electrolysis generator of the present invention.

### DETAILED DESCRIPTION

### Definitions

For the purpose of describing the present invention, the following terms have these meanings:

“Gap distance” means the distance separating the anode and cathode at which evolved oxygen and hydrogen forms microbubbles and nanobubbles.

“Emitter” means a cell comprised of at least one anode and at least one cathode separated by the critical distance.

“Microbubble” means a bubble with a diameter less than 50 microns.

“Nanobubble” means a bubble with a diameter less than that necessary to break the surface tension of water. Nanobubbles remain suspended in the water, giving the water an opalescent or milky appearance.

“Supersaturated” means that a gas, ion or chemical is at a higher concentration than the normal calculated solubility at a particular temperature and pressure.

The embodiments of the present invention described herein are not intended to be exhaustive or to limit the invention to the precise forms disclosed in the following detailed description. Rather, the embodiments are chosen and described so that others skilled in the art can appreciate and understand the principles and practices of the present invention.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

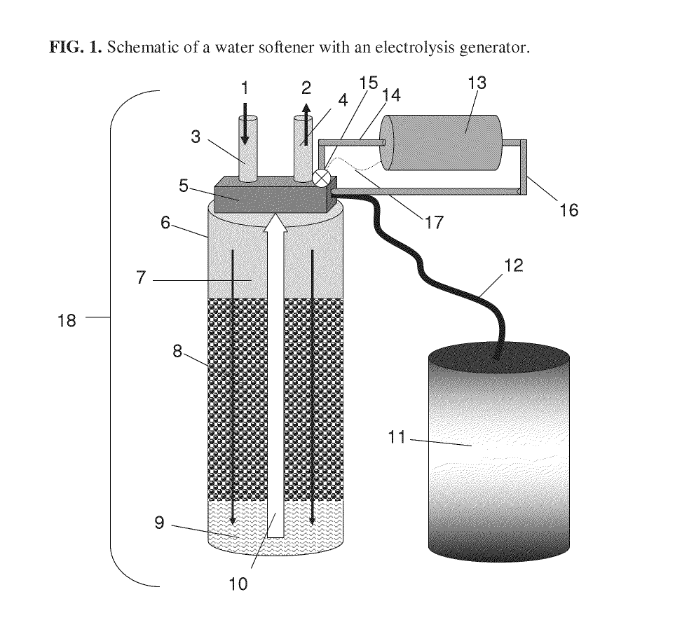

Referring to FIG. 1, the water softener is generally designated as 18, not including parts 13-17. The water softener contains a raw water inlet (1) that flows through the controller, which is generally designated as 5. The controller contains the necessary electronic equipment, programs and valve components necessary to start and stop the regeneration steps. The controller will terminate the softening step in order to initiate the regeneration step. The softening step will be terminated when resin 8 is saturated with hard water ions. This will initiate the regeneration step.

The softener 18 includes a tank (6) that holds a quantity of ion exchange resin 8. Residential and commercial softeners may vary in the number and size of exchange resin tanks that are utilized. Here, FIG. 1 depicts a water softener in which the resin tank (6) and brine tank (11) are separate. Other softeners have resin tanks that are surrounded by a brine tank or salt chamber.

The water softener contains a softening agent in the salt chamber or brine tank 11 such as sodium salts. During softening, the controller 5 operates valves to move fresh, hard water from a supply to flow into the inlet 1. The water flows from the inlet 1 into the resin tank 6 through the ion-exchange resin 8. When the hard water contacts the resin, the hard water ions such as calcium and magnesium are received by the resin and sodium ions are released into the water to make it “soft.” Softened water flows through the bed or filter 9 and into the outlet pipe 10. The softened water may then go into the residence or business through 2 and be used and consumed.

When the resins can no longer exchange sodium for the hard water ions, regeneration of the resins is necessary. To regenerate the resin, softening is halted by the controller 5 and the electrolysis generator 13 is turned on. Generator 13 contains a cathode and anode, and the distance between them ranges from 0.005 inches to 0.140 inches. The generator 13 is an emitter of oxygen and hydrogen microbubbles. When 13 is turned on, valve 15 opens and softened water from outlet 2 or raw water is directed, into generator 13 though pipe 14. Soft water may be preferred as hard water may deposit ions onto the electrodes over time, reducing their efficiency. If hard water is pumped directly into 13, the generator may be designed to specifically reduce the risk of corrosion over time. As the water comes in contact with the electrode in generator 13, oxygen and hydrogen microbubbles and nanobubbles are released to supersaturate the aqueous solution. The supersaturated solution passed through tube 16 into controller 5 and down into the resin tank 6. As the brine solution from the brine tank or salt chamber 11 is pumped into softener tank 6 through connecting tube 12 simultaneously as the supersaturated solution is entering the tank, oxygen and hydrogen microbubbles and nanobubbles disperse the brine solution through the resin 8. Depending on the type of water softener, the brine solution is forced through either downflow or upflow regeneration. It is preferred that the softener utilizes upflow regeneration because the dispersion of the bubbles through the brine and resin may be more efficient. Generator 13 obtains power through 17 and controls through controller 5. The micro- and nanobubbles of oxygen and hydrogen allow for quicker exchange of the hard water ions on the resin for the sodium ions. The bubbles also distribute the solution faster and more evenly throughout the densely packed resin bed 8. When the resin 8 is fully regenerated, valve 15 is closed and generator 13 is turned off. The controller 5 will cease the transfer of brine solution from 11 and 12 into the softener. Excess brine solution will be rinsed from the resin and the softening process will start again.

The present invention produces microbubbles and nanobubbles of oxygen and hydrogen via the electrolysis of water. As molecular oxygen radicals (O^{•}) are produced, they react to form molecular oxygen (O₂). In the special dimensions of the invention, O2 forms bubbles that are too small to break the surface tension of the fluid. These bubbles remain suspended indefinitely in the fluid and, when allowed to build up, make the fluid opalescent or milky. During this time, the water is supersaturated with oxygen. In addition, the hydrogen gas (H₂) readily forms along with protons (H⁺) and hydronium ions (H₃O⁺). When oxygen and hydrogen micro- and nanobubbles are combined with brine solution and resin loaded with hard water ions, the positively charged proton (H⁺) or hydronium ions (H₃O⁺) and oxygen assist in two ways. First, the micro- and nanobubbles help to distribute the brine solution between the small pores of the resin beads, increasing the rate at which the resin can exchange the sodium for the hard water ions. Second, the positively charged protons and hydronium ions help to disassociate the hard water ions and ultimately interchange with the sodium ions to regenerate the resin. Utilizing the electrolysis of water in residential and commercial water softeners will reduce the overall use of sodium and reduce the time necessary for resin regeneration.

What is claimed is:

1. A system for softening water comprising:
an ion exchange resin water softener with control circuit,
a flow through emitter for generation of micro and nanobubbles of oxygen and hydrogen coupled to the water inlet of the water softener and electronically connected to the control circuit such that control circuit activation of a regeneration of the ion exchange resin also activates operation of the flow through emitter.

2. A system according to claim 1 wherein the flow through emitter is configured as a tube containing at least one anode and at least one cathode separated by a gap distance of from about 0.005 inches to about 0.140 inches.

3. A system according to claim 2 wherein the at least one anode and at least one cathode are configured as concentrically arranged, nested wire grid cylinders with their long axes and the long axis of the tube being parallel.

4. A system according to claim 3 wherein the long axes of the wire grid cylinders and the long axis of the tube are the same.

5. A system according to claim 3 wherein multiple anodes and cathodes are present.

6. A system according to claim 2 wherein the at least one anode and at least one cathode are configured as wire grid plates with their long dimension parallel to the long axis of the tube.

7. A system according to claim 1 which softens by exchange of magnesium and calcium salts in the water for sodium chloride of the ion exchange resin and enables a lower use of sodium chloride during the regeneration of the ion exchange resin relative to a system without the flow through emitter.
